(19) United States
(12) Patent Application Publication
(10) Pub. No.: US 2012/0109680 A1
(43) Pub. Date: May 3, 2012

(54) METHOD FOR ENSURING ACCURACY OF HEALTHCARE PATIENT DATA DURING PATIENT REGISTRATION PROCESS

(76) Inventor: PAUL SHORROSH, Mobile, AL (US)

(21) Appl. No.: 13/345,124

(22) Filed: Jan. 6, 2012

Related U.S. Application Data
(63) Continuation of application No. 11/291,134, filed on Nov. 30, 2005, now abandoned.
(60) Provisional application No. 60/676,238, filed on Apr. 29, 2005.

(51) Int. Cl. G06Q 50/22

(52) U.S. Cl. 705/2

(57) ABSTRACT

A method of ensuring accuracy of healthcare patient data entered into a primary computer system by a user during patient registration. Healthcare patient data for a patient entered into the primary computer system is electronically received. The received healthcare patient data is analyzed using a secondary computer processor programmed to identify data entry errors including discrepancies and omissions. The identified errors are automatically presented to the user by the programmed secondary computer processor following analysis of the healthcare patient data. The identified errors are placed into a work list by the programmed secondary computer processor to enable the user to enter corrections for the identified errors into the primary computer system within a designated time-frame.

### CROSS-REFERENCE TO RELATED APPLICATIONS

This is a continuation of U.S. patent application Ser. No. 11/291,134 filed on Nov. 30, 2005, which claims the benefit of U.S. Provisional Patent Application No. 60/676,238, filed on Apr. 29, 2005.

### TECHNICAL FIELD

The embodiments relate generally to computer software. More specifically, the embodiments relate to a computer software program for ensuring the accuracy of healthcare patient data entered into a computer system during patient registration.

### BACKGROUND

For hospitals, doctor's offices, and other similar medical facilities, patient intake is a critical step in their operations. Not only is patient data necessary for proper treatment, but also correct patient data can have a significant impact on the financial operation of the facility. If a patient's intake data is incorrect, financial payment through billing, insurance claims, etc. may be delayed.

Typically, data entry clerks called “registrars” or “patient access representatives” conduct patient intake. The registrars are typically low paid employees that perform a difficult, repetitive and thankless job. Often the employee has inadequate time and resources available for proper training. Additionally, registrars are under pressure to provide speedy and friendly service to all patients. In summary, registrars are tasked with collecting complex and vital information from sick patients as quickly as possible.

Studies have shown that error rates for a typical hospital registration average 30%. These errors generally fall into three categories. The first type is “compliance” errors that deal with legal requirements such as guardianship of a minor seeking admission to the hospital and patient safety issues such as duplicate medical record numbers. The second type is “financial” errors that are necessary to receive payment such as an insurance policy number. Finally, the third type of errors is “operational” errors that will delay payment if incorrect such as an incorrect billing address. The cause of any of these errors may be the result of human error of the registrar, incorrect information provided by the patient, or a change in the patient's information. Even small error rates result in patient safety risk, costly revenue delays and possibly billing write offs due to insurance rejections.

In common insurance industry forms, such as a “UB-92,” eighty six separate data fields are required. Typically, 70% of these fields are entered by registrars rather than billing or clinical staff. Surveys have shown that up to 75% of billing office staff are dedicated to rework or correction of patient data before billing. One prior art solution is manual review of patient data prior to billing. However, this method is limited to random samples of registrations due to high volumes, and is without feedback or accountability to the error makers, so it is ineffective at reducing error rates. Manual review is also burdensome, costly, subjective, inconsistent, and highly dependent upon the skill and ability of the reviewer. Another prior art solution involves the use of “electronic claim validation systems” or “bill scrubbers” which are computer software programs that check the patient data immediately prior to billing. However, this method provides no accountability or statistical analysis of the registrars since billing office staff makes any corrections. Another prior art method involves the use of “pop ups” to prompt the registrar of an error immediately upon entry or directly after each registration is completed. However, this method slows the registration and admissions process for the patient and consequently is not customer friendly.

### SUMMARY

In some aspects, the invention relates to a method for ensuring accuracy of electronic medical patient intake data, comprising: entering medical intake data for a plurality of patients into a computer system; arranging the intake data for the plurality of patients into a batch; analyzing the batch of intake data at a predetermined interval for errors; and generating an alert for errors in the batch of intake data.

In other aspects, the invention relates to a method for ensuring accuracy of electronic medical patient intake data, comprising: step for entering a batch medical intake data for a plurality of patients into a computer system; step for analyzing the batch of intake data at a predetermined interval for errors; and step for generating a report for any errors found in the batch of intake data.

In one embodiment, a method of ensuring accuracy of healthcare patient data entered into a primary computer system by a user during patient registration is provided. Healthcare patient data for a patient entered into the primary computer system is electronically received. The received healthcare patient data is analyzed using a secondary computer processor programmed to identify data entry errors including discrepancies and omissions. The identified errors are automatically presented to the user by the programmed secondary computer processor following analysis of the healthcare patient data. The identified errors are placed into a work list by the programmed secondary computer processor to enable the user to enter corrections for the identified errors into the primary computer system within a designated time-frame.

### BRIEF DESCRIPTION OF DRAWINGS

It should be noted that identical features in different drawings are shown with the same reference numeral.

FIG. 1 shows a display of a main menu in accordance with one embodiment of the present invention.

FIG. 2 shows a display of a maintenance menu in accordance with one embodiment of the present invention.

FIG. 3 shows a display of a report menu in accordance with one embodiment of the present invention.

FIGS. 4A and 4B show displays of a manager report by error type in accordance with one embodiment of the present invention.

FIG. 5A shows a display of a menu used to specify the parameters for an error report in accordance with one embodiment of the present invention.

FIG. 5B shows a display of an error report sent to a registrar to correct errors in accordance with one embodiment of the present invention.

FIG. 6 shows a display of a detailed error report in accordance with one embodiment of the present invention.

FIG. 7 shows a display of a manager report by location and employee in accordance with one embodiment of the present invention.

FIG. 8 shows a display of a manager report by error type in accordance with one embodiment of the present invention.

FIG. 9 shows displays of a manager report for an employee's productivity and error rate in accordance with one embodiment of the present invention.

FIG. 10 shows a display of an error trend report by employee in accordance with one embodiment of the present invention.

FIG. 11 shows a display of insurance eligibility edits in accordance with one embodiment of the present invention.

FIG. 12 shows a display of a selective employee error setup form in accordance with one embodiment of the present invention.

FIG. 13 shows a display of a selective employee error report in accordance with one embodiment of the present invention.

### DETAILED DESCRIPTION

A method for ensuring the accuracy of medical patient intake data has been developed. The present invention involves using a computer software program to “audit” or check the accuracy of patient data entries and identify errors. It can be deployed on a single user computer or on a shared network for simultaneous multi-user access. The checking for errors or “edits” is done periodically by a “batch” of patient entries. A batch is defined as a group of more than one patient. For example, the present invention could audit all of the entries for each patient processed by a registrar once a day. Other embodiments of the invention may audit at different intervals as dictated by the needs of the user. However, audits should take place on the “front end” or before the bills are produced to be sent out for payment. By conducting periodic audits of 100% of all registrations, registrars are allowed to self-correct their errors prior to billing.

Additionally, the present invention can provide managers with statistical data regarding the error rate of patient data entries. Such error rates may be monitored according to employee, error type, or location, etc. This provides management with an objective basis for effective identification of problem areas and subsequent training for employees. Additionally, the registrars may be provided with ongoing feedback of their performance.

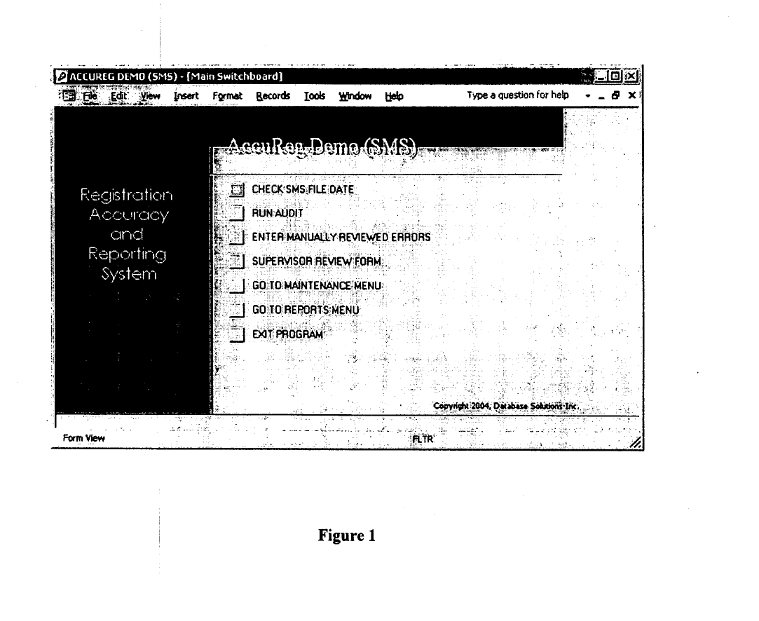

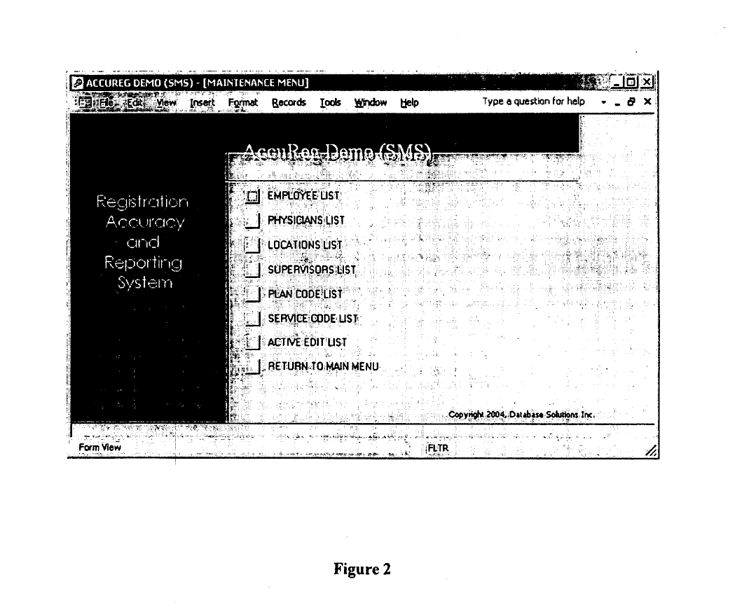

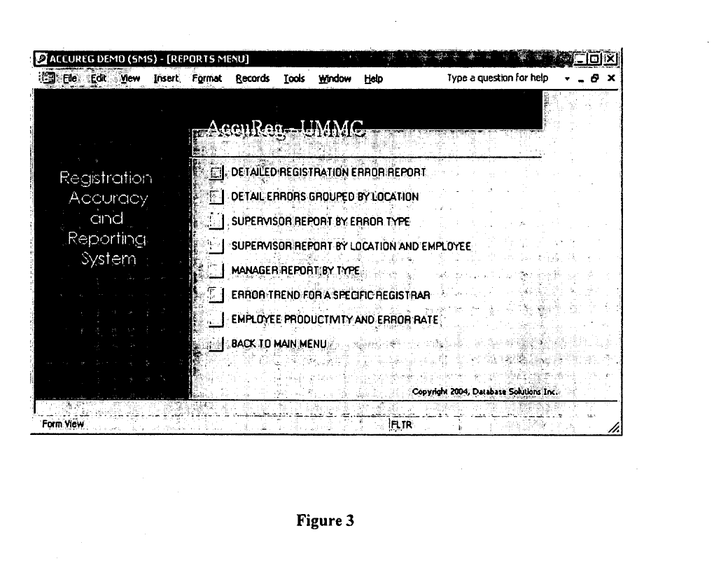

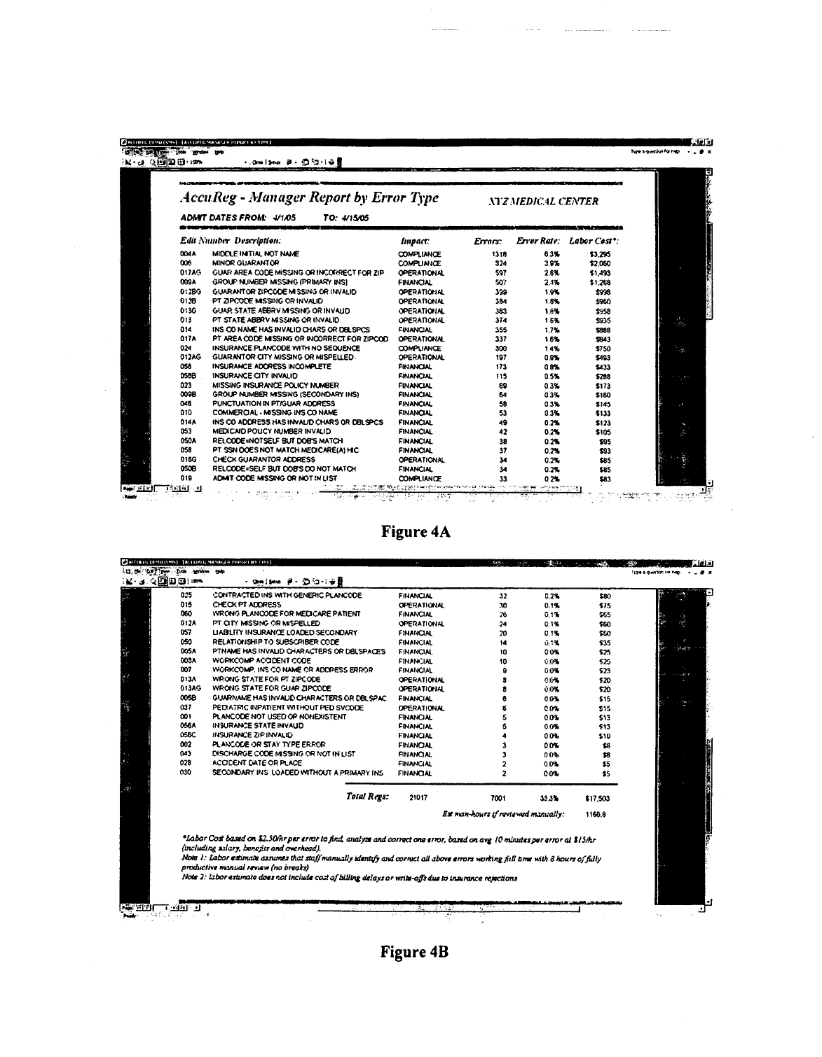

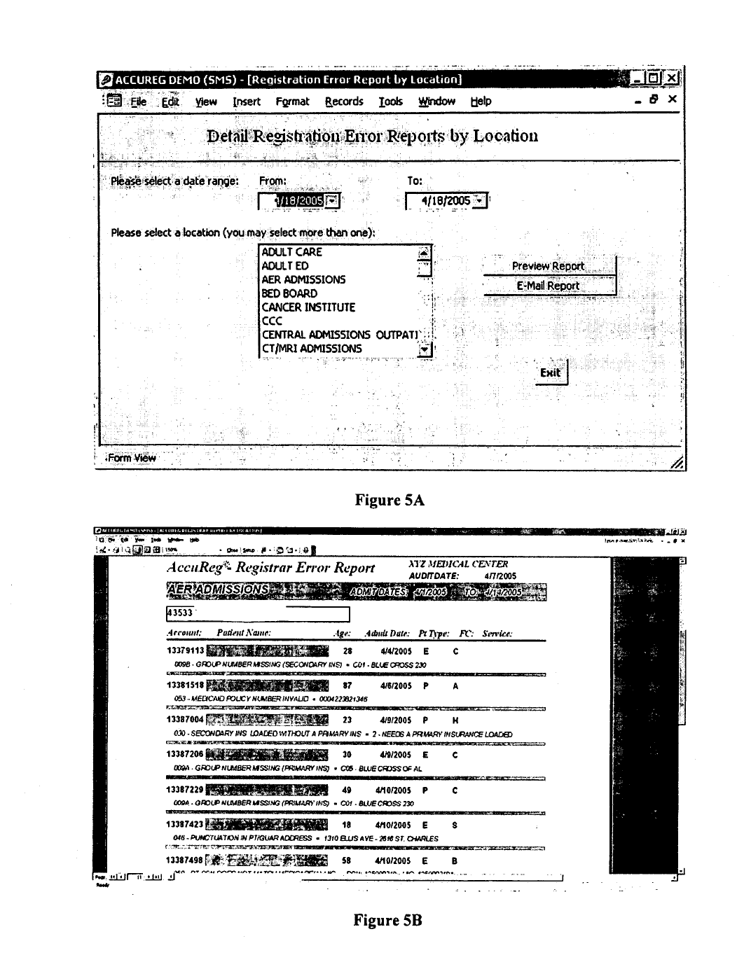

The figures show examples of displays used by one version of the present invention called “AccuReg.” FIGS. 1-3 each show display menus in accordance with one embodiment of the present invention. These menus are used to access and utilize the various features of the invention. FIGS. 4A and 4B show displays of a manager report by error type in accordance with one embodiment of the present invention. The report categorizes the errors by description, type (e.g., compliance, operational, or financial), raw number of a particular error, error rate of a particular error, and cost to correct all errors of a particular type. FIG. 5A shows a screen for specifying the parameters of an error report.

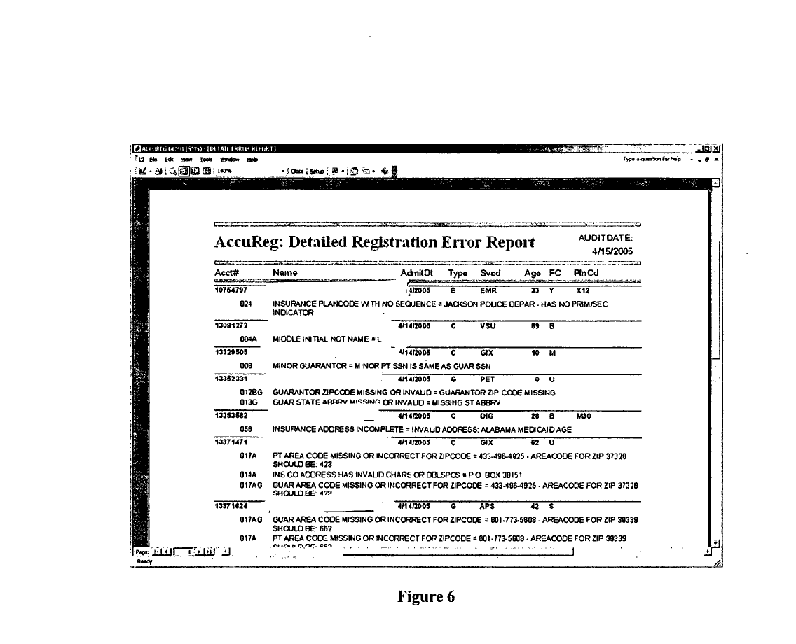

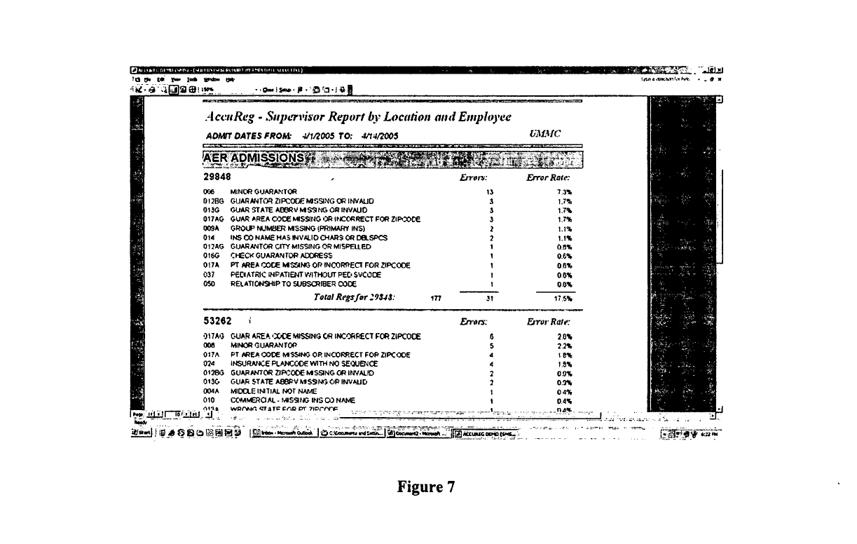

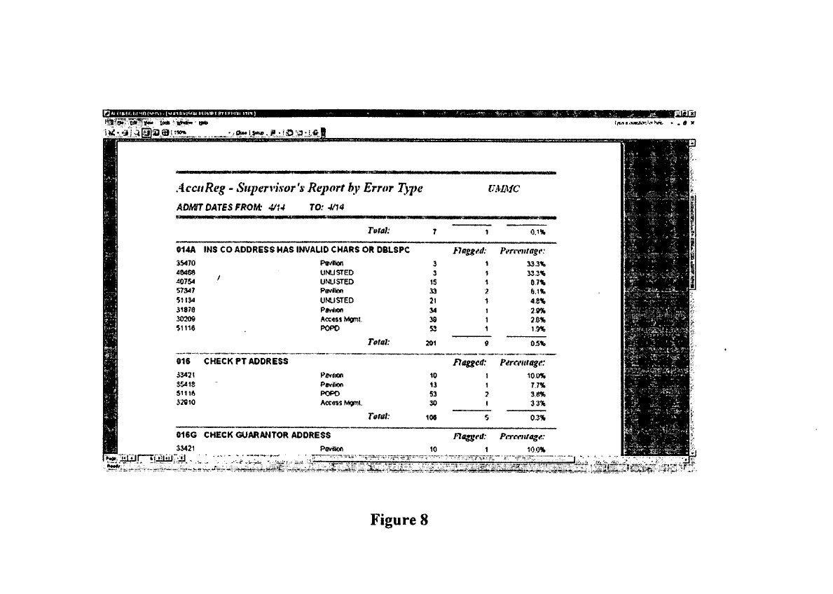

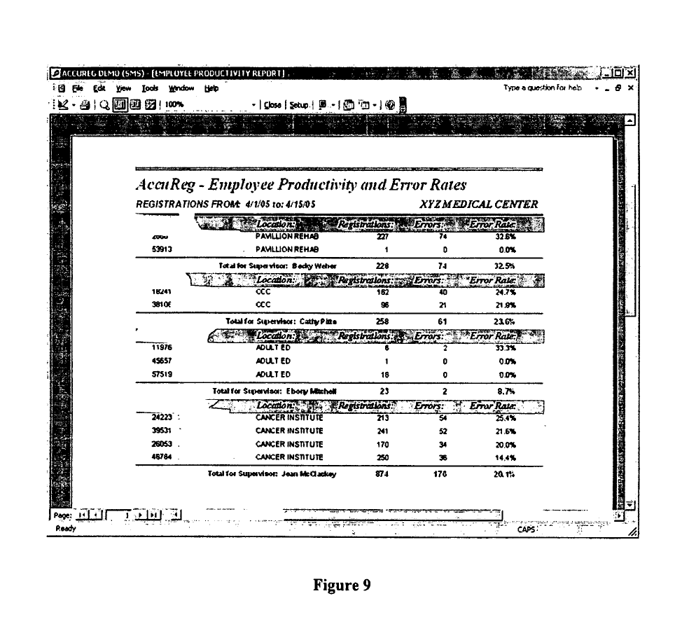

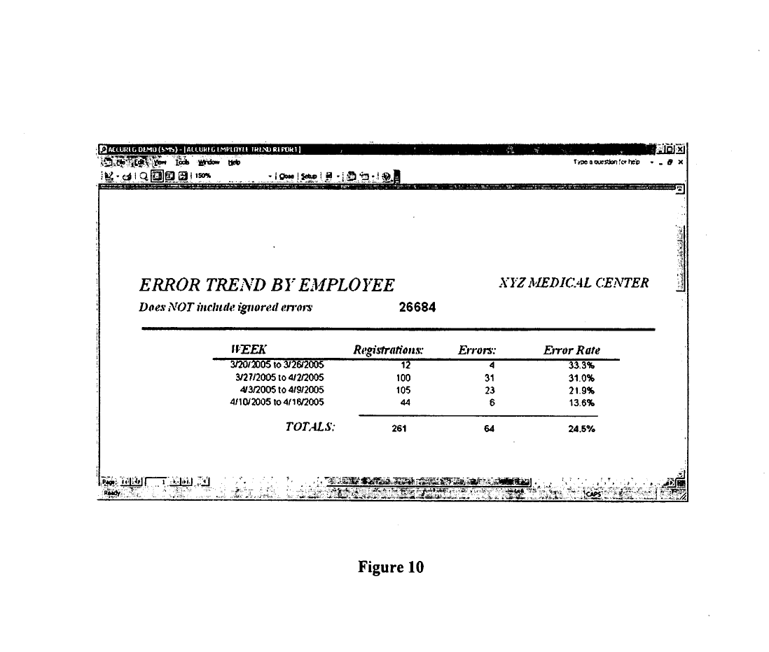

Also shown in FIG. 5B is an example of an error report generated by a periodic audit for a registrar. This is used to correct errors. FIG. 6 shows displays of additional detailed error reports provided to the registrars. FIGS. 7-13 show displays of reports for managers that detail number of errors by individual employees along with their error rate. Also shown are reports that break down error trends and productivity by individual employee, employee group, and overall performance. As clearly shown, the present invention provides a great deal of flexibility to managers in the way information regarding error rates is collected. It should be understood that alternative embodiments of the present invention may utilize the reporting capability in a variety of ways according to the needs of the user.

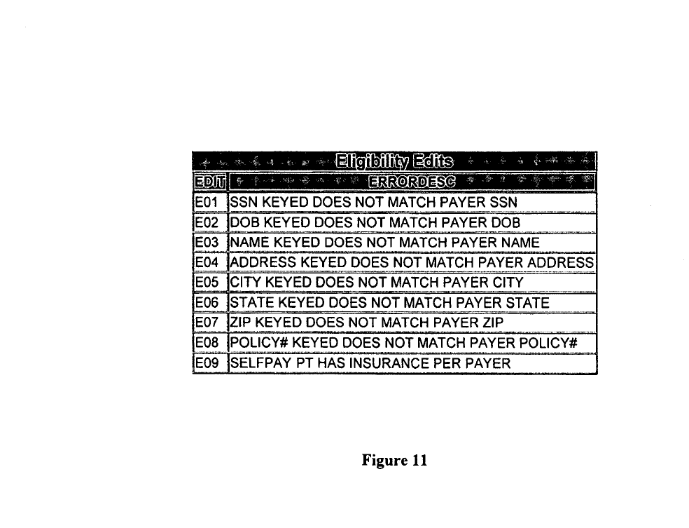

Some additional features of the invention may include the use of “eligibility edits.” This is a particular type of edit that uses data from a hospital's electronic eligibility system to identify registration errors. An electronic eligibility system returns demographic and insurance information to the registrar for the purpose of verifying coverage, benefits and co-pay information. Since the source of this eligibility information is insurance company or other payer databases, it is arguably the most accurate storehouse of information regarding the patient and subscriber. It is also the information that insurance companies require on the claim forms in order for them to reimburse the providers without delay or denial. FIG. 11 shows examples of these edits. However, due to the time constraint during registration and the complexity of the information, many hospitals do not take full advantage of this information.

The use of eligibility edits allow the hospital to identify errors by comparing specific data elements keyed by the registrar to the same data elements according to the payer's database. For example, the social security number keyed by the registrar is compared to the social security number according to the insurance eligibility transaction file for that patient. If the registrar mis-keyed even one out of the expected nine digits, the invention will identify the error and report it to the clerk in the registrar's daily error report along with other errors. The report will show registrars what was keyed incorrectly as well as what should have been keyed according to the payer, allowing them to efficiently make corrections so that the billing cycle is not impacted. This new capability significantly improves the invention's ability to positively impact the revenue cycle of a hospital by enforcing the use of eligibility data that the hospital is already paying for but not using.

Another feature of the invention may include the use of “second pass reporting.” This feature is a double check that insures errors reported will be corrected. The present invention will re-audit accounts that were audited 2 to 3 days before to make sure the errors were corrected during that period of time. If the same error appears at a specified interval (e.g., 3 days) after it was first reported to the employee, the supervisor and employee are made aware of it with “second pass reports.” It is a second pass or second opportunity to identify and correct errors. Supervisors will be able to view summary statistics to identify employees who routinely fail to correct errors on the first pass. Furthermore, accounts that were improperly corrected are identified; insuring even greater accuracy and employee accountability. This reporting capability is unique and adds an enforcement aspect to insure hospital managers that errors will be corrected. It also insures that the invention will produce results for the hospital in terms of prevention of denials and reduction of rework.

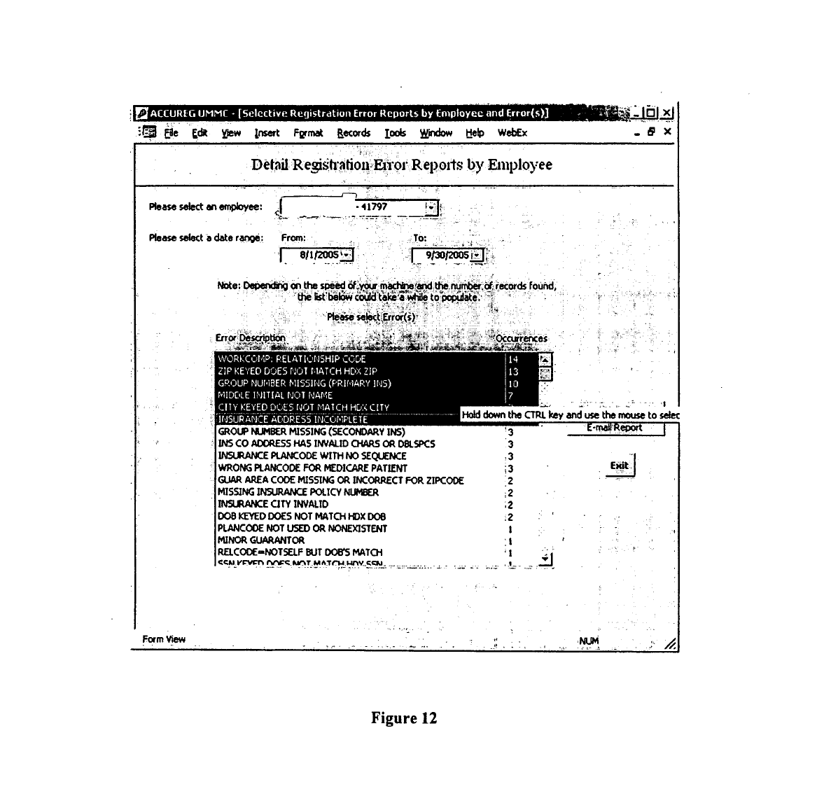

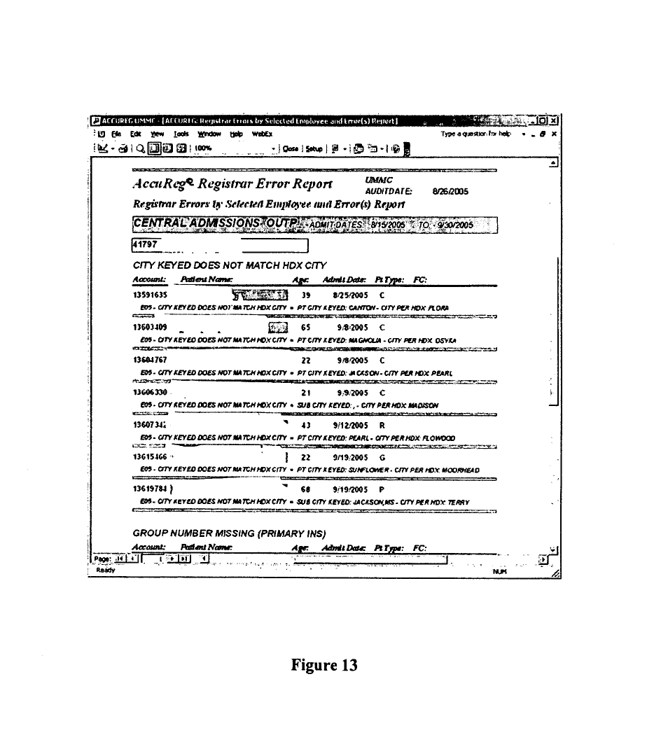

Some embodiments of the invention allow a supervisor to select an employee, to choose a time frame, to select one or more of that employee's top errors for that period, and then choose to print or email a detailed retrospective list of those errors. This provides the supervisor with the ability to quickly produce select detailed error information for any employee for management or retraining purposes. A screenshot of the setup form is shown in FIG. 12, followed by a sample report shown in FIG. 13.

Other embodiments of the invention utilize “double-check” edits. These edits involve particular situations where an error type is difficult to consistently and accurately identify (e.g., a misspelled name, incorrect zip code, incorrect area code). In this embodiment, the invention can set any edit to “double-check” status, meaning that the edit will report the possible error to the employee on their error report with instructions to double check the entry. This indicates to the employee that they should conduct a second review of the data and correct it if necessary. Additionally, the invention allows managers to set any edit to be reported but not counted against the employee's statistics or affect their accuracy rates. This is useful to managers in cases such as “double-check” edits, where the managers can enforce errors to be reported and reviewed but not necessarily counted.

Embodiments of the present invention include a wide variety of formats for the presentation of data. For example, the reports generated by the invention may be accessed only by managers in some configurations. Because the registration employees do not need access to the software to obtain reports and demonstrate accountability, there is no need to train and re-train dozens or hundreds of registrars to use it. This adds an important accountability step to the process where the employee receives their daily error report from their supervisor.

In certain embodiments, a manager would prefer to get a particular edit or error type reported to them as a “worklist” rather than to the employee for correction. For example, duplicate medical record numbers can be a patient safety risk so a manager may choose to report that particular error separately for only the manager to correct. A “worklist edit” allows a manager to keep such errors from reporting to the employees for correction, and allows the manager a way to find and fix the error with full knowledge of which employee made the error, but report and correct it in a different way than normal edits.

Other embodiments of the invention will contain full color bar and line charts within the generated reports. This significantly improves the readability of the reports and makes interpretation and decision making more efficient for managers. The invention may also produce a report to demonstrate to hospital managers the financial return on their investment (ROI). For example, the ROI may be calculated by determining the labor expense saved due to reduction of rework or the denials prevented due to early detection and correction.

The present invention results in a significant reduction in the error rate of patient admissions. Additionally, management is provided with statistical tools to identify and correct problem areas as they occur. While the embodiments of the present invention have been described with respect to admission of patients to a hospital, the invention could apply to admission to other medical facilities such as a doctor or dentist office. Further, the invention could also be applied to any non-medical organizations where the intake of customer data is critical to administrative functions. In summary, the advantages of the present invention include: front-end auditing of patient intake data in periodic batches; allowing for employee accountability and improvement of employee competency; and reporting of errors to management in a format that allows for analysis of error statistics.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the appended claims.

What is claimed is:

1. A method of ensuring accuracy of healthcare patient data entered into a primary computer system by a user during patient registration, comprising:
electronically receiving healthcare patient data for a patient entered into the primary computer system;
analyzing the received healthcare patient data using a secondary computer processor programmed to identify data entry errors including discrepancies and omissions;
automatically presenting the identified errors to the user by the programmed secondary computer processor following analysis of the healthcare patient data; and
placing the identified errors into a work list by the programmed secondary computer processor to ensure corrections to the identified errors are entered into the primary computer system within a designated time-frame.

2. The method of ensuring accuracy of healthcare patient data of claim 1 wherein the user enters healthcare patient data into the primary computer system using a data entry device.

3. The method of ensuring accuracy of healthcare patient data of claim 1 wherein the identified errors are presented simultaneously to the user by a display device both as alerts and as a retrospective work list.

4. The method of ensuring accuracy of healthcare patient data of claim 1 wherein the identified errors are categorized by an impact to an organization as any one of a compliance error, a financial error, and an operational error.

5. The method of ensuring accuracy of healthcare patient data of claim 1 further comprising comparing specific data elements entered by the user with corresponding data elements obtained from an insurance payer database by an electronic eligibility system to identify specific data entry errors.

6. The method of ensuring accuracy of healthcare patient data of claim 5 wherein the electronic eligibility system returns demographic and insurance information for the patient stored in the insurance payer database in order to verify insurance coverage, benefits, and patient payment information.

7. The method of ensuring accuracy of healthcare patient data of claim 1 further comprising periodically re-auditing of the identified errors to confirm that the corrections have been made and automatically marking the identified errors as corrected.

8. The method of ensuring accuracy of healthcare patient data of claim 7 further comprising identifying errors that persist after the user makes corrections, reporting the persistent errors to the user, and automatically marking the persistent errors as uncorrected.

9. The method of ensuring accuracy of healthcare patient data of claim 8 further comprising providing a statistical summary to a supervisor to identify any user that marks the identified errors as corrected but fails to correct the identified errors in the primary computer system.

10. The method of ensuring accuracy of healthcare patient data of claim 1 further comprising prompting the user to recheck specific data elements for data entry errors.

11. The method of ensuring accuracy of healthcare patient data of claim 1 further comprising automatically providing particular data entry error types representing a patient safety risk to a user's manager for correction.

12. A system for ensuring accuracy of healthcare patient data entered into a primary computer system by a user during patient registration, comprising:
a data storage device for storing healthcare patient data for a plurality of patients;
a programmable computer processor for executing a plurality of software components including:
a component adapted for receiving healthcare patient data that was entered into the primary computer system using a data entry device;
a component adapted for analyzing the received healthcare patient data to identify data entry errors including discrepancies and omissions;
a component adapted for automatically presenting the identified errors to the user immediately following analysis of the healthcare patient data; and
a component adapted for placing the identified errors into a work list to ensure corrections to the identified errors are entered into the primary computer system within a designated time-frame.

13. The system for ensuring accuracy of healthcare patient data of claim 12 wherein the identified errors are presented to the user using a display device.

14. The system for ensuring accuracy of healthcare patient data of claim 12 wherein the identified errors are categorized by an impact to an organization as any one of a compliance error, a financial error, and an operational error.

15. The system for ensuring accuracy of healthcare patient data of claim 12 further comprising a component adapted for comparing specific data elements entered by the user with corresponding data elements for the patient obtained from an insurance payer database via an electronic eligibility system to identify specific data entry errors.

16. The system for ensuring accuracy of healthcare patient data of claim 15 wherein the electronic eligibility system returns demographic and insurance information for the patient stored in the insurance payer database in order to verify insurance coverage, benefits, and patient payment information.

17. The system for ensuring accuracy of healthcare patient data of claim 12 further comprising a component adapted for periodically re-auditing of the identified errors to confirm that the corrections have been made and automatically marking the identified errors as corrected.

18. The system for ensuring accuracy of healthcare patient data of claim 17 further comprising a component adapted for identifying errors that persist after the user makes corrections, reporting the persistent errors to the user, and automatically marking the persistent errors as uncorrected.

19. The system for ensuring accuracy of healthcare patient data of claim 18 further comprising a component adapted for providing a statistical summary to a supervisor to identify any user that marks the identified errors as corrected but fails to correct the identified errors in the primary computer system.

20. The system for ensuring accuracy of healthcare patient data of claim 12 further comprising a component for prompting the user to recheck specific data elements for data entry errors.

21. The system for ensuring accuracy of healthcare patient data of claim 12 further comprising a component adapted for automatically providing particular data entry error types representing a patient safety risk to a user's manager for correction.

22. A non-transitory computer readable medium containing instructions for ensuring accuracy of healthcare patient data entered into a primary computer system by a user during patient registration when executed on a programmed secondary computer processor, by:
receiving healthcare patient data for a patient entered into the primary computer system;
analyzing the received healthcare patient data using the secondary computer processor to identify data entry errors including discrepancies and omissions;
automatically presenting the identified errors to the user following analysis of the healthcare patient data; and
placing the identified errors into a work list by the programmed secondary computer processor to ensure corrections to the identified errors are entered into the primary computer system within a designated time-frame.

23. The non-transitory computer readable medium for ensuring accuracy of healthcare patient data of claim 22 by comparing specific data elements entered by the user with corresponding data elements from an insurance payer database by an electronic eligibility system to identify specific data entry errors.

24. The non-transitory computer readable medium for ensuring accuracy of healthcare patient data of claim 23 wherein the electronic eligibility system returns demographic and insurance information for the patient stored in the insurance payer database in order to verify insurance coverage, benefits, and patient payment information.

25. The non-transitory computer readable medium for ensuring accuracy of healthcare patient data of claim 22 by periodically re-auditing of the identified errors to confirm corrections have been made to the identified errors and automatically marking the identified errors as corrected.

26. The non-transitory computer readable medium for ensuring accuracy of healthcare patient data of claim 25 by identifying errors that persist after the user makes corrections, reporting the persistent errors to the user, and automatically marking the persistent errors as uncorrected.

27. The non-transitory computer readable medium for ensuring accuracy of healthcare patient data of claim 22 by providing a statistical summary to a supervisor to identify any user that marks the identified errors as corrected but fails to correct the identified errors in the primary computer system.

28. The non-transitory computer readable medium for ensuring accuracy of healthcare patient data of claim 22 by prompting the user to recheck specific data elements for data entry errors.

29. The non-transitory computer readable medium for ensuring accuracy of healthcare patient data of claim 22 by automatically providing particular data entry error types representing a patient safety risk to a user's manager for correction.
